(19) United States
(12) Patent Application Publication
(10) Pub. No.: US 2010/0277761 A1
(43) Pub. Date: Nov. 4, 2010

(54) INFORMATION PROCESSING APPARATUS, INSTALLATION METHOD OF PRINTER DRIVER, AND PROGRAM

(75) Inventor: Masayuki Sakura, Kawasaki-shi (JP)

Correspondence Address: CANON U.S.A. INC. INTELLECTUAL PROPERTY DIVISION, 15975 ALTON PARKWAY, IRVINE, CA, 92618-3731, US

(73) Assignee: CANON KABUSHIKI KAISHA, Tokyo (JP)

(21) Appl. No.: 12/768,622

(22) Filed: Apr. 27, 2010

(30) Foreign Application Priority Data
May 1, 2009 (JP) 2009-112192

(51) Int. Cl. G06F 15/00

(52) U.S. Cl. 358/1.15

(57) ABSTRACT

An information processing apparatus includes a print system that is a program for managing a printer driver. The information processing apparatus stores a printer driver module of a general-purpose printer driver constituted by a binary object different from the printer driver in a memory of the apparatus already installed with a printer driver. The apparatus searches registration information of a printer already registered in the print system, and determines whether printer-related information registered in the print system can be used in relation to the searched registration information. The apparatus uses information of a printer queue included in the registration information of the already registered printer and the printer-related information to register a printer that uses the general-purpose printer driver in the print system if it is determined that the printer-related information can be used.

### BACKGROUND OF THE INVENTION

1. Field of the Invention

The present invention relates to installation of a printer driver.

2. Description of the Related Art

Conventionally, there is a proposed method for holding queue information, registration information, and setting information of an already installed printer driver when performing, for example, a version upgrade of the printer driver.

In Japanese Patent Application Laid-Open No. 2003-208276, initialization information is stored in advance in a storage area of a server connected to a network to prevent the setting from returning to the default when installing a printer driver to upgrade the version. A method of installing a new printer driver based on the initialization information is proposed. The format of the initialization information is determined in advance, and a new printer driver is created to be able to interpret the initialization information of an old version when the version is upgraded.

In this way, information of printers (queue information) registered in the old version, user environment setting files, etc. can be taken over when the version of the printer driver is upgraded. This allows the user to save the effort of re-registering the information of the printer or resetting the user environment in the newly installed printer driver.

### SUMMARY OF THE INVENTION

An information processing apparatus is provided which includes a print system that is a program for managing a printer driver. The information processing apparatus comprises: a storage unit that stores a printer driver module of a general-purpose printer driver constituted by a binary object different from the printer driver in a memory of the information processing apparatus already installed with a printer driver; a search unit that searches registration information of a printer already registered in the print system; a determination unit that determines whether printer-related information registered in the print system can be used in relation to the registration information searched by the search unit; and a registration unit that uses information of a printer queue included in the registration information of the already registered printer and the printer-related information to register a printer that uses the general-purpose printer driver in the print system if the determination unit determines that the printer-related information can be used.

Further features of the present invention will become apparent from the following description of exemplary embodiments with reference to the attached drawings.

### BRIEF DESCRIPTION OF THE DRAWINGS

FIG. 1 is a diagram illustrating an example of a system in which the present invention is applied.

FIG. 2 is a block diagram illustrating a hardware configuration of a computer 101.

FIG. 3 is a block diagram illustrating a configuration of a printer driver.

FIG. 4 is a flow chart illustrating an installation procedure of the printer driver.

FIG. 5 is a flow chart illustrating a procedure for registering the printer driver.

FIG. 6 is a diagram illustrating a printer registration user I/F.

FIG. 7 is a diagram illustrating a printer registration dialog.

FIG. 8 is a system block diagram illustrating a state in which a printer is already registered.

FIG. 9 is a diagram illustrating printer registration information describing information of a printer to be registered.

FIG. 10 is a diagram illustrating a file to which the printer registration information is added.

FIG. 11 is a diagram illustrating an example of a printer specification description file.

FIG. 12 is a diagram illustrating a storage location and file names of printer specification description files.

FIG. 13 is a diagram illustrating an example of a printer setting file.

FIG. 14 is a diagram illustrating a storage location and file names of printer setting files.

FIG. 15 is a diagram illustrating a user I/F of an individually corresponding printer driver.

FIG. 16 is a diagram illustrating a printer specification description file of the individually corresponding printer driver.

FIG. 17 is a diagram illustrating a user I/F of a general-purpose printer driver.

FIG. 18 is a diagram illustrating a printer specification description file of the general-purpose printer driver.

FIG. 19 is a flow chart illustrating an installation procedure of a first embodiment of the present invention.

FIG. 20 is a flow chart illustrating a process of S1913 of FIG. 19 in detail.

FIG. 21 is a diagram illustrating a list of printers created by an installer.

FIG. 22 is a functional capacity table created from the printer specification description file of FIG. 16.

FIG. 23 is a functional capacity table created from the printer specification description file of FIG. 18.

FIG. 24 is a printer specification description file of an individually corresponding printer driver.

FIG. 25 is a functional capacity table created from the printer specification description file of FIG. 24.

FIG. 26 is a diagram illustrating an example of an option setting dialog related to deletion of a printer.

FIG. 27 is a flow chart illustrating an installation procedure of a second embodiment of the present invention.

FIG. 28 is a printer specification description file of a general-purpose printer driver.

FIG. 29 is a diagram illustrating a page description language handled by a printer acquired from the printer.

### DESCRIPTION OF THE EMBODIMENTS

Preferred embodiments of the present invention will now be described in detail in accordance with the accompanying drawings.

First, a prerequisite technique of the present embodiments will be described.

Functions can just be added/deleted or changed in a printer driver for which the version will be upgraded. It is difficult to make a change to a printer driver with totally different functions or to a different page description language. For example, the case in which a printer driver is created according to individual printers will be considered. If a printer can perform stapling and punching, the printer driver that individually corresponds to the printer has a control that allows setting stapling and punching in a user I/F.

A case of creating a printer driver with a totally different concept from the individually corresponding printer driver will be considered. For example, a case of creating a general-purpose printer driver that only has general-purpose functions applicable to any printer and that includes a user I/F in a configuration totally different from that of the individually corresponding printer driver will be considered. The general-purpose printer driver is software constituted by binary objects totally different from the individually corresponding printer driver.

In this case, setting files and related files of the general-purpose printer driver are individually handled, as opposed to the files of the individually corresponding printing driver. Therefore, a procedure of version upgrade as in the conventional example cannot be performed when the user wants to use the general-purpose driver.

The user first has to delete the individually corresponding printer driver to install the new general-purpose printer driver. Furthermore, the general-purpose printer driver is installed as a new printer driver. Therefore, there is a problem that the user has to perform setting of the environment of the printer driver, etc. all over again, which takes a great deal of effort. In the example, a mechanism for converting the registration information and the setting information of the individually corresponding printer driver into information for the general-purpose printer driver can be created in the general-purpose printer driver. However, there is a problem that the creation of the mechanism for conversion takes a great deal of effort by the provider of the printer driver.

Furthermore, in the example, the functions of the general-purpose printer driver may be superior or inferior to the functions of the individually corresponding printer driver. In that case, the user needs to compare the functions to determine whether to install the general-purpose printer driver.

This is not so cumbersome for the user if the user uses only one printer. However, if the user uses a plurality of printers, the user needs to compare the functions of the printer drivers to determine whether to install the general-purpose printer driver. This is an operation that takes a significantly great deal of effort.

There is another problem in a different case. Page description languages of an already installed printer driver and a printer driver to be newly installed may be different. An example of the case is when one printer supports a plurality of page description languages. Printer drivers with different page description languages are handled as totally different software even if the printer drivers are compatible with the same model type. Therefore, as described, the user needs to first delete the old printer driver to install the new printer driver with different page description language. As in the example described above, the printer driver with different page description language is installed as a new printer driver. Therefore, there is a problem that the user needs to perform setting of the environment of the printer driver, etc. all over again, which takes a great deal of effort.

In both examples, the old printer driver does not always have to be deleted when the new printer driver is installed. Therefore, an effort of deletion is not mandatory. However, the user needs to register the printer again (registration of print queue) or set the printer driver after installation of the new printer driver, which takes a significantly great deal of effort.

In another case, the old printer driver has to be deleted. An example of the case is when the user upgrades the version of the operating system, and the old printer driver cannot be operated. In this case, the user needs to delete the old printer driver, which takes a significantly great deal of effort.

Preferred embodiments of the present invention will now be described with reference to the drawings.

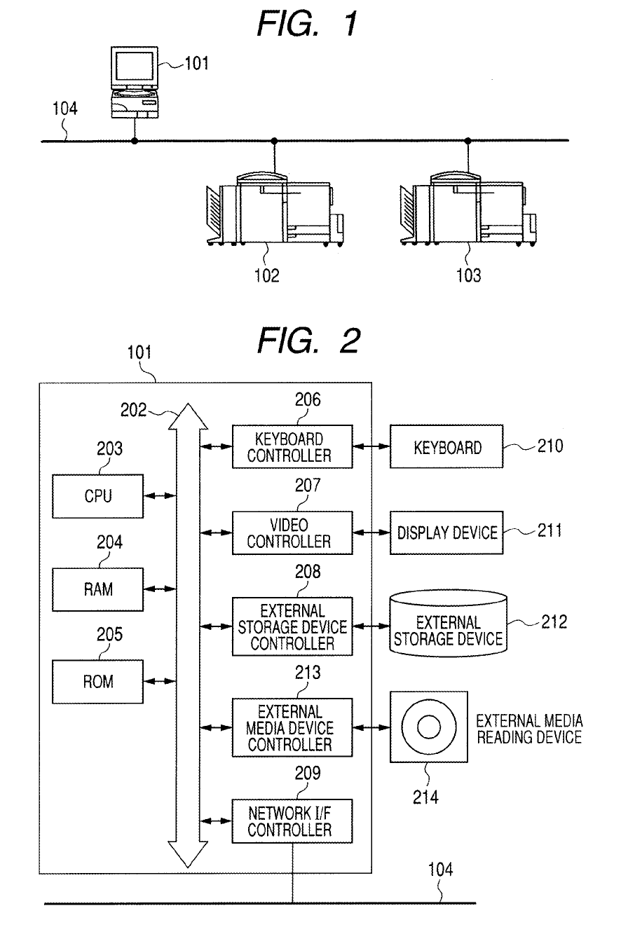

A first embodiment of the present invention will be illustrated with reference to FIGS. 1 to 26.

### <System Configuration>

FIG. 1 is a diagram illustrating an example of a system in which the present invention is applied.

In FIG. 1, reference numeral 104 denotes a computer network. A client computer 101 (hereinafter, computer 101) and network printers 102 and 103 are connected to the network 104.

An operating system (OS (including print system)), an application, a printer driver, etc. are installed in the computer 101. The system allows the user to transmit user data from the computer 101 to the printer 102 or 103 to print the data.

The present embodiment illustrates an example of installing a general-purpose printer driver (generic printer driver) on a computer operating on an OS using CUPS as a print system. The general-purpose printer driver is not dependent on a specific printer model type and is a versatile printer driver that allows a wide variety of printers to execute a printing process.

The computer 101 of the present embodiment is a computer operating on an OS using CUPS as a print system.

More specifically, the computer 101 is a computer using CUPS as a print system.

The CUPS denotes Common Unix Printing System. The CUPS is implemented as a standard print system on various OSs based on UNIX (registered trademark), such as Mac OS X or later and Linux (registered trademark), and is operated on the UNIX-based OSs (usually, operated as daemon). In the description of the present embodiment, the CUPS is included in a package of the OS. The parts described as operations performed by the OS may include operations performed by the CUPS. The CUPS may be installed separately from the OS. The CUPS uses IPP (Internet Printing Protocol) for the management of print jobs and queues. The CUPS further uses PPD (PostScript Printer Description) for the description of functions usable by printers.

FIG. 2 is a block diagram illustrating a hardware configuration of the computer 101.

In FIG. 2, reference numeral 203 denotes a central processing unit (CPU). Reference numeral 204 denotes a RAM which is a volatile memory. Reference numeral 205 denotes a ROM which is a non-volatile memory.

Reference numeral 206 denotes a keyboard controller. A keyboard 210 for the user to operate the computer and a pointing device (for example, mouse) not shown are connected to the keyboard controller 206. The keyboard controller 206 controls input from the keyboard 210 and the pointing device.

Reference numeral 207 denotes a video controller. A display device 211 is connected to the video controller 207. The video controller 207 controls output to the display device 211. Reference numeral 208 denotes an external storage device controller. A non-volatile external storage device 212 (for example, hard disk) for storing a large amount of data is connected to the external storage device controller 208. The external storage device controller 208 controls reading and writing of data to and from the external storage device 212.

Reference numeral 209 denotes a network I/F controller. The network I/F controller 209 controls connection to the network. The computer 101 can use the network I/F controller 209 to communicate with other devices (102 and 103) connected to the computer network 104.

Reference numeral 213 denotes an external media device controller. An external media reading device 214 is connected to the external media device controller 213. The external media device controller 213 controls reading of an external medium (CD-ROM or DVD-ROM) set to the external media reading device 214. For example, when the external medium, etc. provides applications, driver software, etc., the user can set the medium, such as CD-ROM, to the external media reading device 214 to cause the computer 101 to read the programs.

Usually, an initial program for activating the computer 101 and basic programs for controlling the modules of the computer 101 are stored in the ROM 205. The OS (including print system), applications, printer drivers, etc. are stored in the external storage device 212. When the power of the computer 101 is applied, the CPU 203 first executes a program for activating the computer stored in the ROM 205. The program (or the CPU 203 that executes the program) loads the OS stored in the external storage device to the RAM 204 and then transfers the control right to the OS. The operations performed by the CPU 203 executing the OS will be expressed as actions, etc. performed by the OS.

The OS further reads necessary modules and drivers from the external storage device 212 to the RAM 204. The OS also reads necessary applications from the external storage device 212 to the RAM 204 based on an instruction by the user and executes the applications.

The printer driver and the installer of the printer driver described in the present embodiment are supplied by an external medium, such as a CD-ROM. The user sets the external medium to the external media reading device 214. The CPU 203 reads the printer driver and the installer from the external medium to the RAM 204 as necessary or stores the printer driver and the installer in the external storage device 212.

### <Printer Driver>

The printer driver will now be described.

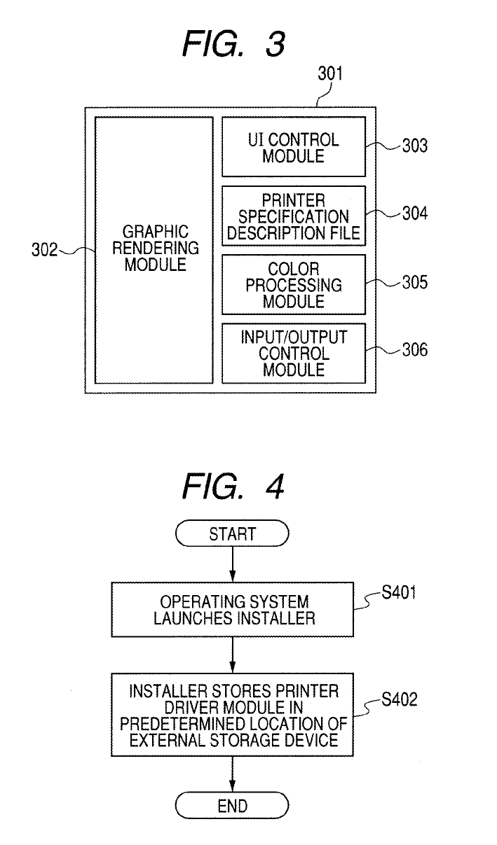

FIG. 3 is a block diagram illustrating a configuration of the printer driver.

The printer driver is constituted by a module group shown in FIG. 3.

As shown in FIG. 3, a printer driver 301 includes a module group, such as a graphic rendering module 302, a UI control module 303, a printer specification description file 304, a color processing module 305, and an input/output control module 306. The printer driver may include other modules depending on the functions of the printer driver.

The graphic rendering module 302 renders print data received from the print system of the OS to print data (page description language; PDL) understandable by the printer device. The UI control module 303 displays functions usable by the printer based on the printer specification description file 304 describing functions usable by the printer (printer specification information) or receives setting from the user. The color processing module 305 executes color processing based on an ICC profile. The input/output control module 306 transmits print data to the printer.

There are several ways of creation by the printer driver. For example, the graphic rendering module 302 and the UI control module 303 are created to be able to be compatible with a plurality of printers to allow one printer driver to handle a plurality of printers. In the method, the printer specification description files are included in the printer driver for an amount of the corresponding printers. According to the method, the UI control module 303 controls the display of the UI according to the printer specification description file 304. The graphic rendering module 302 issues page description languages and printer control commands according to the printers.

In another method, a printer specification description file 304 that is not dependent on a specific model type and that is compatible only with functions common to a wide variety of printers is created. The UI control module 303 also operates according to the printer specification description file. The graphic rendering module 302 further generates a general-purpose page description language that allows a wide variety of printers to print, according to the printer specification description file.

In the description of the present embodiment, the former printer driver will be called an individually corresponding printer driver (monolithic printer driver), and the latter printer driver will be called a general-purpose printer driver (generic printer driver).

A procedure of installing the printer driver configured this way on the computer 101 will now be described.

FIG. 4 is a flow chart illustrating an installation procedure of the printer driver. The CPU 203 executes a printer driver installer (hereinafter, installer) on the OS to realize the process of the flow chart. The user prepares a CD-ROM storing the printer driver or obtains the installer through the network.

When the user first performs an operation of activating the installer, the OS detects the operation and activates the installer (S401). The operations executed by the CPU 203 executing the OS will be expressed as actions, etc. performed by the OS with the OS as a subject. The operations executed by the CPU 203 executing the installer on the OS will be expressed as actions, etc. performed by the installer with the installer as a subject.

The activated installer reads the printer driver module from the CD-ROM, etc. and stores the printer driver module in a predetermined location of the external storage device 212 (S402). The storage location of the printer driver module varies depending on the print system. For example, in the CUPS, the printer driver modules are stored under a “/Library/Printers/” directory for each vendor. The printer drivers can be further classified by the type and stored under the directories of the vendors. For example, when there are different printer drivers “PrinterC PDL1” and “PrinterC PDL2” of a vendor “ABC Company”, the following is performed. A directory “/Library/Printers/ABC Company/PrinterC PDL1/” is first created for “PrinterC PDL1”. A directory “/Library/Printers/ABC Company/PrinterC PDL2/” is created for “PrinterC PDL2”. The printer driver of the PDL1 and the printer driver of the PDL2 are stored under corresponding directories.

Although this completes the installation of the printer driver, the user needs to use the printer driver to register the printer in the print system to actually allow output to the printer.

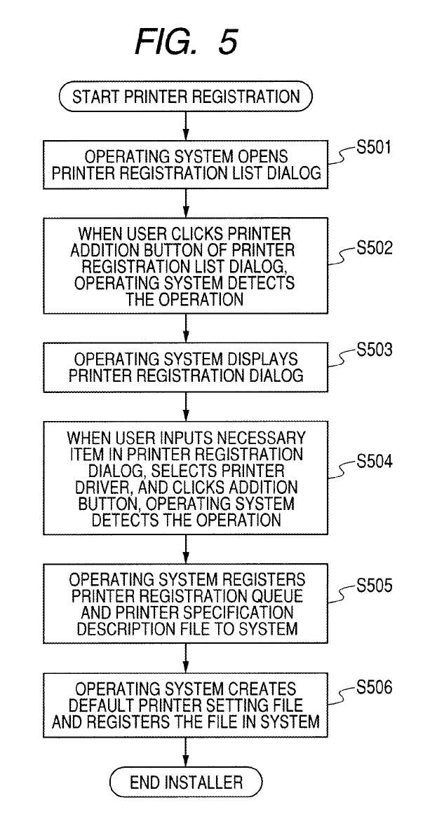

FIG. 5 is a flow chart illustrating a procedure of registering the printer driver. The flow will be described with reference to necessary drawings along with the procedure. The CPU 203 executes the OS to realize the process of the flow chart. The operations executed by the CPU 203 executing the OS will be expressed as actions, etc. performed by the printer driver with the printer driver as a subject.

When the user performs an operation of opening a dialog of printer registration, the OS detects the operation and opens the dialog of printer registration. In this step, the OS reads a program code for the printer registration from the external storage device 212 to the RAM 204 and executes the program code.

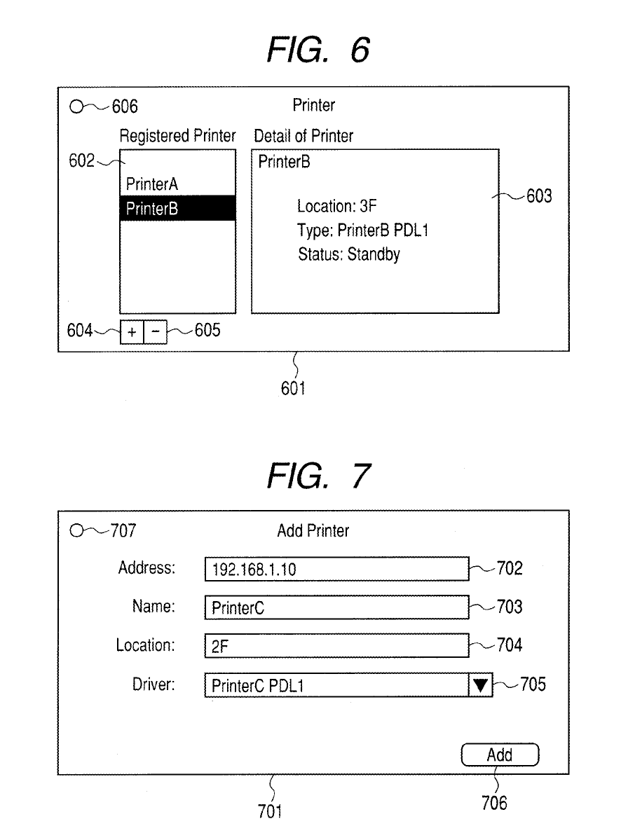

FIG. 6 is a diagram illustrating a printer registration user I/F.

This dialog includes a registered printer list 602 for displaying a list of currently registered printers and a printer detail display area 603 for displaying detailed information of a printer selected in the registered printer list 602.

Reference numeral 604 denotes a button for registering printers. Reference numeral 605 denotes a button for deleting a printer currently selected in the registered printer list 602. Reference numeral 606 denotes a button for closing the dialog.

The flow chart of FIG. 5 will now be described again.

When the user clicks the printer addition button 604 of the printer registration user I/F 601, the OS detects the operation (S502) and displays a printer registration dialog 701 (FIG. 7) (S503). When the user performs an operation of inputting necessary information described below, selecting a printer driver, and adding a printer in the displayed printer registration dialog 701 (FIG. 7), the OS detects the operation (S504) and proceeds the process to step S505.

FIG. 7 is a diagram illustrating a printer registration dialog.

In the printer registration dialog 701, reference numeral 702 denotes a control for designating a network address (IP address in the example) of the connected printer. Reference numeral 703 denotes a control for inputting the name of the printer to identify the printer. Reference numeral 704 denotes a control for inputting the location where the printer is arranged. Character strings input to the name input control 703 of the printer and the location input control 704 of the printer are character strings used for display in the registered printer list 602 and the printer detail display area 603 shown in FIG. 6.

Reference numeral 705 denotes a control for designating a printer driver used to register the printer. The OS lists the printer drivers listed in the control 705 and stored in the printer driver storage directory (/Library/Printers) described above.

The example of FIG. 7 illustrates a state in which the address is “192.168.1.10”, the name is “PrinterC”, the location is “2F”, and “PrinterC PDL1” is selected as the printer driver. When the user clicks an addition button 706 in this state, the OS detects the operation and executes a printer adding process (S505 of FIG. 5). The user clicks a dialog close button 707 to close the dialog without adding a printer.

The flow chart of FIG. 5 will now be described again.

In step S505, the OS registers printers to the system based on the information designated by the user in the printer registration dialog. More specifically, the OS registers a printer registration queue and a printer specification description file to the print system.

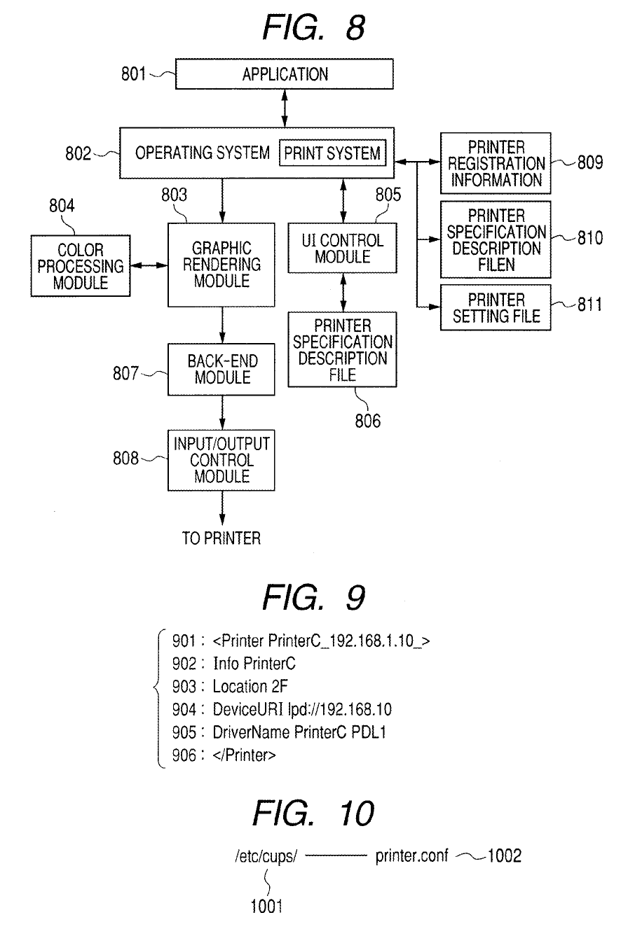

In step S506, the OS creates a default printer setting file based on the printer specification description file, registers the printer setting file in the print system, and ends the process. The printer setting file is a file describing user setting information for the printer. The two steps (S505 and S506) will be described in detail with reference to FIGS. 8 to 14.

FIG. 8 is a system block diagram illustrating a state in which printers are already registered in the computer 101.

A graphic rendering module 803 shown in FIG. 8 corresponds to the graphic rendering module 302 of the printer drivers registered in a predetermined directory (/Library/Printers/) of the OS based on the procedure described above.

Similarly, a UI control module 805 corresponds to the UI control module 303 of the registered printer driver. A color processing module 804 corresponds to the color processing module 305 of the registered printer driver. An input/output control module 808 corresponds to the input/output control module 306 of the registered printer driver. A printer specification description file 806 corresponds to the printer specification description file 304 of the registered printer driver.

A back-end module 807 is provided by the OS 802 and is a module for transferring print data generated by the graphic rendering module 803 to the input/output control module 808. The input/output control module 808 that has received the print data from the back-end module 807 transmits the data to the printer. The OS 802 generates printer registration information 809, a printer specification description file 810, and a printer setting file 811 in the process of printer registration of FIG. 5, and the details will be described below.

In step S505 of FIG. 5, the OS 802 collects information of the printer registration dialog and executes a registration operation of printers to the print system. The registration operation is executed as follows.

FIG. 9 is a diagram illustrating printer registration information describing information of a printer to be registered. The printer registration information is described in a markup language.

In FIG. 9, reference numeral 901 denotes an identifier of printer which describes the printer name and the address of the printer following the underscore. Reference numeral 902 describes the name of the printer. Reference numeral 903 describes the installation location of the printer. Reference numeral 904 describes a print queue, and in the example, data will be transmitted to an address “192.168.1.10” by the 1pd protocol. Reference numeral 905 describes the printer driver name used by the printer. Reference numeral 906 indicates that the description of the printer is finished.

In step S505 of FIG. 5, the OS 802 creates the description of FIG. 9 and adds the description to a predetermined file of the external storage device 212 as printer registration information of the printer.

FIG. 10 is a diagram illustrating a file to which the printer registration information is added.

In the example of FIG. 10, the information is added to a “printer.conf” file 1002 stored in an “/etc/cups/” directory 1001. As a result of the addition, the printer registration information (including information of printer queue) of the printer to be registered is registered in the print system of the OS 802. The information serves as the printer registration information 809.

Subsequently, the OS 802 registers a printer specification description file to the system. The registration operation is executed as follows.

In FIG. 8, the print system of the OS 802 acquires the printer specification description file of the printer to be registered from the UI control module 805 of the printer driver to register the file to a predetermined part of the system. The printer specification description file will be described before the description of the registration method of the printer specification description file.

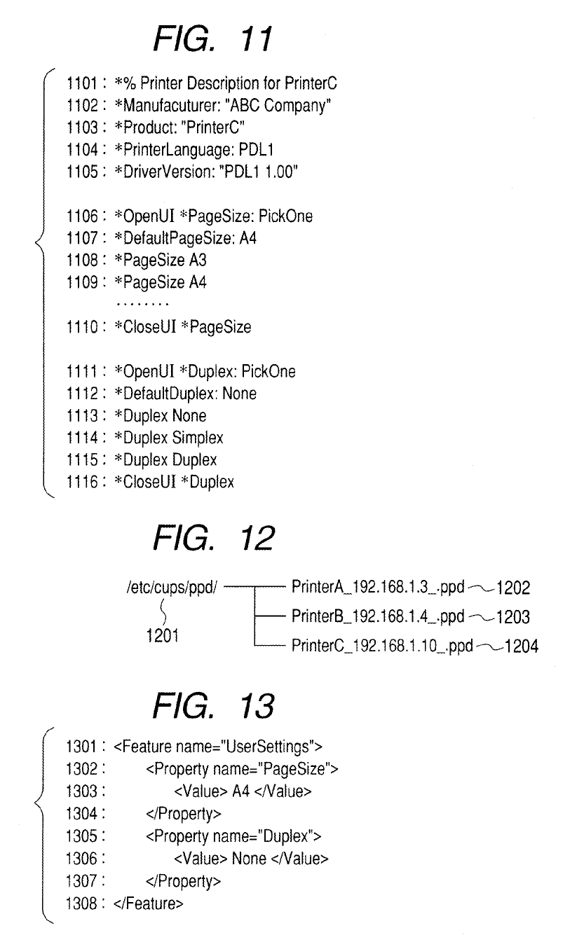

FIG. 11 is a diagram illustrating an example of the printer specification description file. The printer specification description file is described according to a specification description format of the printer. The format is also taken into consideration in the following description.

In FIG. 11, reference numeral 1101 describes a comment. The head of the line of the comment is “*%”. Reference numeral 1102 describes a vendor name. Reference numeral 1103 describes the printer name handled by the printer specification description file. Reference numeral 1104 describes a page description language handled by the printer specification description file. Reference numeral 1105 describes a version of the printer driver. The description of a functional specification of the printer follows. In the functional specification, from the line of “*OpenUI” to the line of “*CloseUI” denotes one function. After “OpenUI”, the function name with “*” attached to the top is shown. The function name is followed by the separator “:”, and a type of the function is shown. The types include “PickOne” and “Boolean”, and “PickOne” indicates a function of selecting one of the choices. “Boolean” indicates that the function is controlled by On/Off.

Reference numeral 1106 includes a function “*PageSize” and indicates that one of the choices will be selected for the function. A default value of the function is described in the line following 1106. The line starts with “*Default”, and the function name defined in the previous line is attached. The line indicates that the default of the function “PageSize” is “A4”. One choice of the function is described in each line from the following line to “*CloseUI” of reference numeral 1110. For example, reference numeral 1108 indicates that one of the choices of “PageSize” is “A3”. This describes a function of selecting the page size, and choices in the middle are not shown because there are a multiplicity of choices for the page size. The last description of the function is reference numeral 1110, and the function name described with “*OpenUI” is described after “*CloseUI”. The foregoing expresses one function. The following reference numerals 1111 to 1116 describe another function. Overlapping description will not be repeated. In this block, there is a function “Duplex”, and one of the choices is selected for the function. The choices include “None”, “Simplex”, and “Duplex”. This actually expresses a function of duplex printing designation. The default setting of the printer is followed in the case of “None” because there is no designation. “Simplex” denotes one-sided printing, and “Duplex” denotes two-sided printing.

The registration method of the printer specification description files will now be described. The OS 802 acquires the printer specification description files corresponding to the printers to be registered from the UI control module 805 and stores the files in a predetermined location of the system as shown in FIG. 12.

FIG. 12 is a diagram illustrating the storage location and the file names of the printer specification description files. As shown in FIG. 12, the storage location of the printer specification description files is an “/etc/cups/ppd/” directory 1201 of the external storage device 212. As shown with reference numerals 1202 to 1204, the printer specification description files to be stored in the storage location include file names formed by names of the printers to be registered, and following the underscores, addresses of the printers to be registered are attached. More specifically, the printer specification description files of the printers to be registered are files of extension “ppd” with the identifiers (901 of FIG. 9) of the printers to be registered as the file names. The printer specification description file 810 added here is “PrinterC192.168.1.10_.ppd” indicated by reference numeral 1204.

As a result of the storage of the printer specification description file of the printer to be registered in a predetermined location of the system as shown in FIG. 12, the printer specification description file of the printer to be registered is registered in the print system. The file serves as the printer specification description file 810.

In step S506 of FIG. 5, the OS 802 creates a file describing the default printer driver setting based on the printer specification description file and registers the file in the system as the printer setting file 811.

FIG. 13 is a diagram illustrating an example of the printer setting file. The file is described in a markup language, and interpretations are made based on the keys of the markups.

In FIG. 13, reference numerals 1301 and 1308 denote that the default setting is described between the lines. Reference numerals 1302 to 1304 describe the default setting of PageSize, and the default value is “A4”. This is realized by the OS interpreting the printer specification description file (FIG. 11) registered in the external storage device 212, finding a key “*DefaultPageSize” from the function description content of “*PageSize”, and converting the file into the description of 1302 to 1304.

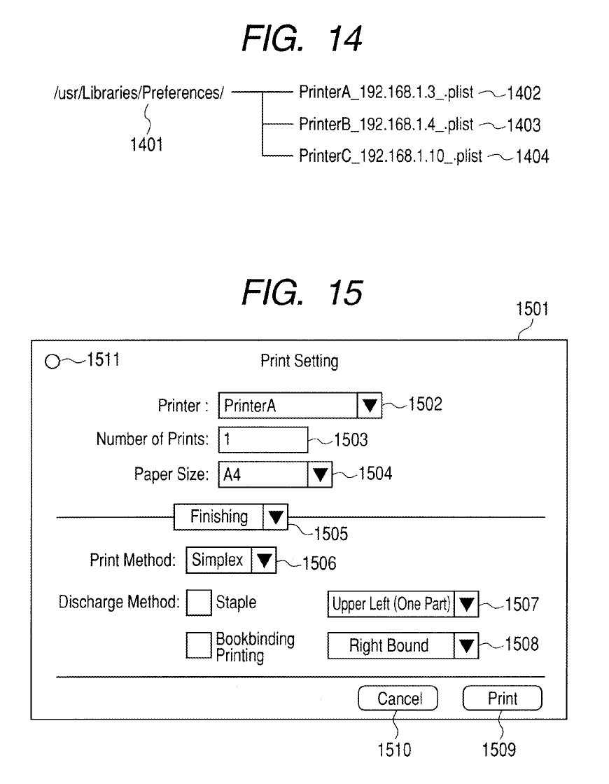

In the same way, reference numerals 1305 to 1307 describe that the default setting value of the function of Duplex is “None”. The OS 802 stores the default setting description of the printer created here in the external storage device 212, with the location and the file name shown in FIG. 14.

FIG. 14 is a diagram illustrating the storage location and the file names of the printer setting files.

As shown in FIG. 14, the storage location of the printer setting file is a “/usr/Libraries/Preferences/” directory 1401 of the external storage device 212. As shown with reference numerals 1402 to 1404, the printer setting files to be stored in the storage location include file names formed by names of the printers, and following the underscores, addresses of the printers are attached. More specifically, the printer setting files of the printer to be registered are files of extension “plist” with the identifiers (901 of FIG. 9) of the printers to be registered as the file names. As a result of the storage of the printer setting file of the printer to be registered in the predetermined location of the system as shown in FIG. 14, the printer setting file of the printer to be registered is registered in the print system. The file serves as the printer setting file 811.

The user uses the printer setting file 811 to change the default setting. Specifically, the user I/F of the printer driver is displayed, and the user changes the setting value. When there is an instruction for saving the change, the UI control module 805 accesses the printer setting file 811 through the OS 802 to change the setting value of the relevant function. As a result, for example, when the user wants to always use a printer with duplex setting, the user can change the default to duplex through the printer driver.

In this way, the OS 802 completes the registration of the printer designated by the user to the print system. The print system reads the printer registration information 809, the printer specification description file 810, and the printer setting file 811 to allow the execution of the printing process of the registered printer.

Two types of printer drivers to be described in the present embodiment will now be described.

FIG. 15 is a diagram illustrating a user I/F of a printer driver created to fully support the functions specific to the printer (individually corresponding printer driver). The user I/F of the printer driver is created to be able to control all functions included in the printer.

For example, in a print setting dialog 1501, reference numerals 1502 to 1504 denote controls commonly provided by the system, and basic functions can be performed, such as setting of the number of prints and designation of the paper size.

The functions specific to the printer can be set in other parts. If there are a multiplicity of functions in the printer, there is a method of switching the functional genre in 1505, without displaying all functions at once. The state illustrated here indicates that a function related to “Finishing” is displayed.

The function related to “Finishing” includes simplex/duplex designation of 1506, stapling designation of 1507, and bookbinding printing designation of 1508. There are various other functions, and the genre can be switched for display by the designation of the control of 1505.

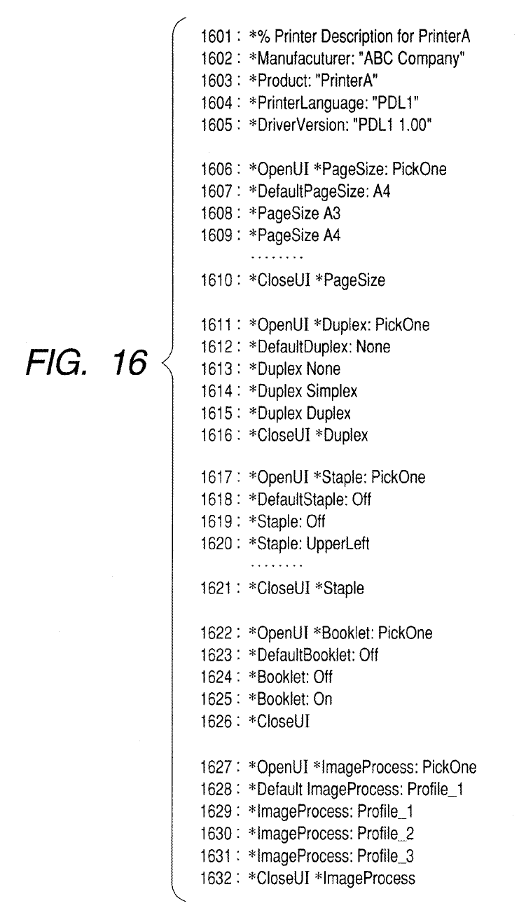

FIG. 16 is a diagram illustrating a printer specification description file of the individually corresponding printer driver. Only the part of the printer specification description file necessary for the description is illustrated.

In FIG. 16, reference numerals 1601 to 1605 describe information related to the printer. Reference numerals 1606 to 1610 describe a page size function. Reference numerals 1611 to 1616 describe a duplex printing function, and the printer driver displays the control 1506 of the duplex function of FIG. 15 based on the description. Reference numerals 1617 to 1621 describe a staple function, and part of the choices is described in FIG. 16 as there are a multiplicity of choices. Reference numerals 1622 to 1626 describe a bookbinding printing function. Reference numerals 1627 to 1632 describe an image processing function, and choices of the function include “Profile_{—}1”, “Profile_{—}2”, and “Profile_{—}3”. However, the function is related to color processing and is not displayed in FIG. 15. The function can be displayed and set by switching the functional genre of 1505 to “Color Processing”.

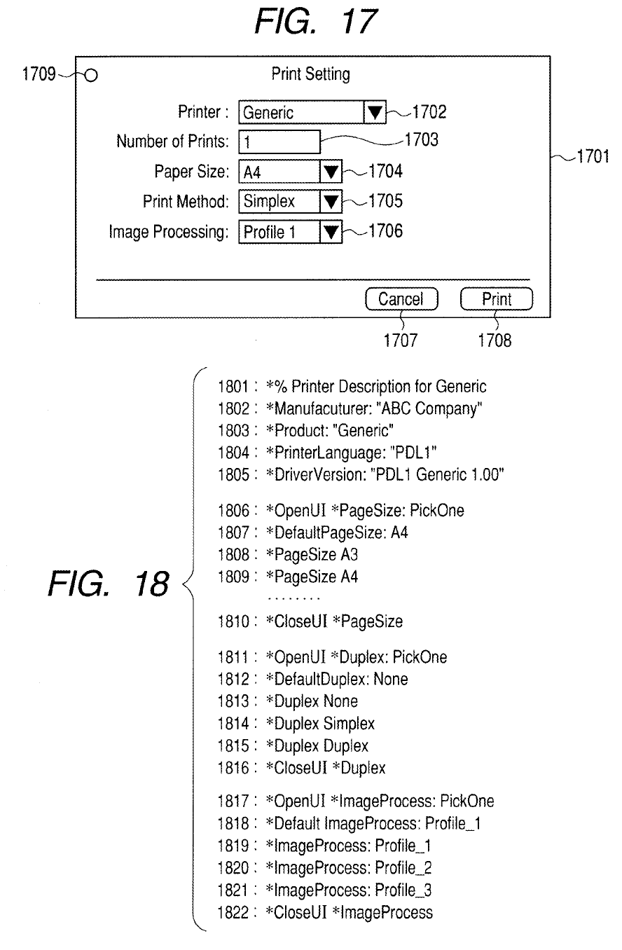

The printer driver corresponding to FIGS. 17 and 18 is a type of printer driver different from the printer driver corresponding to FIGS. 15 and 16. Specifically, the printer driver corresponding to FIGS. 17 and 18 includes different binary objects from the printer driver corresponding to FIGS. 15 and 16, and the method of providing the functions is also different.

FIG. 17 is a diagram illustrating a user I/F of a printer driver (general-purpose printer driver) created for general-purpose use in a wide variety of printers. The functions that can be set are limited in the general-purpose printer driver, and only the functions of paper size, printing method, and image processing are provided in any printer specification description file. Therefore, only one type of printer specification description file is prepared. The general-purpose printer driver is suitable for a wide variety of printers, and a new printer driver does not have to be installed even if the user adds a printer. The user can use the general-purpose printer driver to use the same user I/F as before. The vendor does not have to develop a printer driver for each printer, either. Providing such a general-purpose printer is advantageous for both the user and the vendor. The general-purpose printer driver can just interpret functions “*PageSize”, “*Duplex”, and “*ImageProcess” to register the printer even if a multiplicity of functions are described in the printer specification description file.

FIG. 18 is a diagram illustrating a printer specification description file of the general-purpose printer driver.

In FIG. 18, reference numerals 1801 to 1805 describe information related to the printer. Reference numerals 1806 to 1810 describe a page size function. Reference numerals 1811 to 1816 describe a duplex printing function, and the printer driver displays a control 1705 of the duplex function of FIG. 17 based on the description. Reference numerals 1817 to 1822 describe an image processing function, and choices of the function include “Profile_{—}1”, “Profile_{—}2”, and “Profile_{—}3”. The printer driver displays a control 1706 of the image processing function based on the description.

The following describes an embodiment in which the general-purpose printer driver is installed, and the individually corresponding printer driver, which is already installed, is replaced by the general-purpose printer driver. As described, since the functions of the individually corresponding printer driver and the general-purpose printer driver greatly vary, the binary objects of the individually corresponding printer driver and the general-purpose printer driver are different. Therefore, the directories, in which the printer drivers are installed, are different directories under a “/Library/Printers/VendorName/” directory. This is different from the version upgrade of a normal printer driver in which a version upgrade driver is installed while the printer driver of an old version is already installed.

In the case of the version upgrade of a normal printer driver, the driver is installed by overwriting the directory of the already installed printer driver by the version upgrade driver. This is a significantly different point between the replacement of the individually corresponding printer driver by the general-purpose printer driver and the version upgrade of the conventional normal printer driver.

### <Installation Procedure>

A procedure of installing a printer driver and registering a printer according to the present invention will be described. In the description, it is assumed that individually corresponding printer drivers “PrinterA PDL1” and “PrinterB PDL1” are already installed on the computer 101. It is also assumed that “PrinterA” is registered as a printer that uses “PrinterA PDL1”, and “PrinterB” is registered as a printer that uses “PrinterB PDL1”. The installation of the general-purpose printer driver described in FIGS. 17 and 18 on the computer 101 will be described.

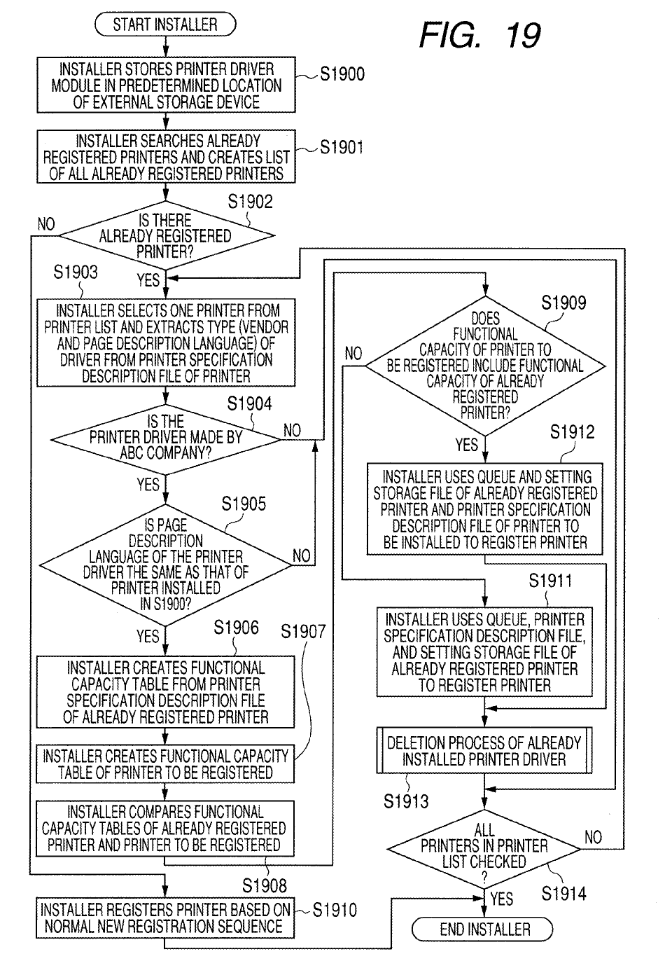

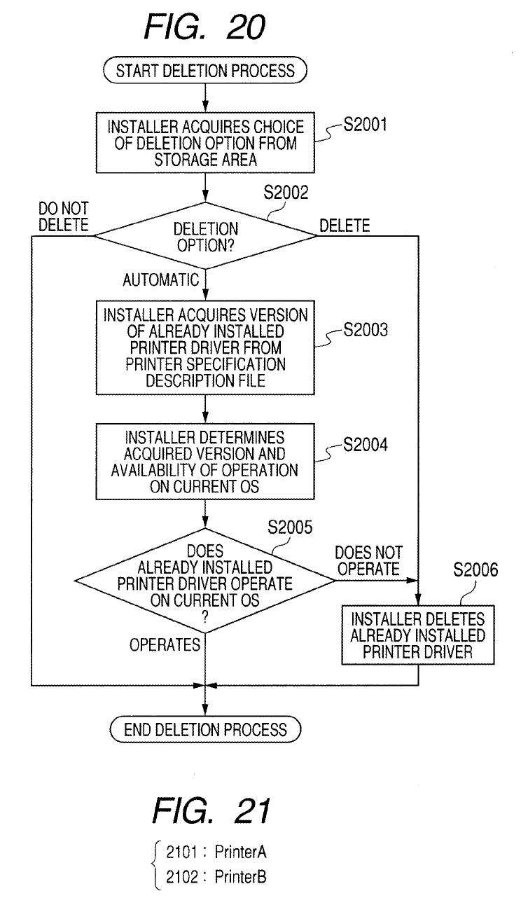

FIGS. 19 and 20 are flow charts illustrating an installation procedure of the first embodiment of the present invention. The procedure will be described with reference also to FIGS. 21 to 26. The flow chart of FIG. 20 illustrates step S1913 of FIG. 19 in detail.

The user operates to activate the installer of the general-purpose printer driver stored in a storage medium such as a CD-ROM. After detecting the operation, the CPU 203 loads an installer program to the RAM 204 and executes the program on the OS. The operation executed by the CPU 203 executing the installer on the OS will be expressed as an action, etc. performed by the installer with the installer as a subject.

In step S1900, the installer reads a printer driver module of a general-purpose printer driver from a storage medium such as a CD-ROM and stores the module in a predetermined location of the external storage device 212 (installs a printer driver). In the case of a printer driver “PDL1 Generic” of a vendor “ABCCompany”, the printer driver module is stored in a “/Library/Printers/ABCCompany/PDL1 Generic/” directory.

In step S1901, the installer searches printers already registered in the print system to create a list. Specifically, the installer reads, to the RAM 204, “printer.conf” 1002 stored in the “/etc/cups/” directory 1001 of the external storage device 212. The installer further searches a keyword starting with “<Printer” from the read “printer.conf” 1002 and extracts the printer name from the line. For example, in “printer.conf” of FIG. 9, the line 901 starts with “<Printer”. Therefore, the printer name, or specifically, the character string following “<Printer” can be extracted from the line by a procedure of deleting the IP address between the underscores. In the example of FIG. 9, “PrinterC” is obtained. This is applied to the entire “printer.conf” 1002 to list the registered printers.

FIG. 21 is a diagram illustrating a list of the printers created by the installer.

In the example shown in FIG. 21, “PrinterA” shown with reference numeral 2101 and “PrinterB” shown with reference numeral 2102 are listed.

In step S1902, the installer determines whether there is a printer already registered. If the installer determines in S1902 that there is no printer already registered (there is no printer listed in S1901), the process proceeds to step S1910. In step S1910, the installer executes a registration process of a normal printer shown in FIG. 5.

On the other hand, if the installer determines in S1902 that there is a printer already registered (there is a printer listed in S1901) as shown in FIG. 21, the process proceeds to step S1903. In step S1903, the installer sequentially selects printers one by one from the list of the printers (FIG. 21) and extracts types of drivers (vendor names and page description languages) from the printer specification description files of the selected printers (hereinafter, “registered printers”). If “PrinterA” is the registered printer, the installer extracts the type of the driver from the printer specification description file of “PrinterA” (PrinterA_{—}192.168.1.3_.ppd stored in/etc/cups/ppd). An example of the printer specification description file of “PrinterA” (FIG. 16) will be used to specifically describe the extraction of the type of the driver (vendor name and page description language). The vendor name is extracted from “*Manufacturer”. Therefore, it can be recognized from 1602 that the vendor name is ABC Company. The page description language is extracted from “*PrinterLanguage”. Therefore, it can be recognized from 1604 that the page description language is “PDL1”.

In step S1904, the installer determines whether the printer driver used by the registered printer is a product of ABC Company based on the vendor name extracted in S1903. If the installer determines in S1904 that the printer driver used by the registered printer is a product of ABC Company, the process proceeds to step S1905. Since the vendor name is “ABC Company” in the example of “PrinterA”, the installer determines that the driver is a product of ABC Company and advances the process to step S1905.

On the other hand, if the installer determines in S1904 that the printer driver used by the registered printer is not a product of ABC Company, the process proceeds to step S1914.

In step S1905, the installer determines whether the page description language of the printer driver used by the registered printer is the same as the page description language of the general-purpose printer driver installed in S1900 (hereinafter, simply “general-purpose printer driver”). If the installer determines in S1905 that the page description languages are the same, the installer advances the process to step S1906. For example, it can be recognized that the page description language of the general-purpose printer driver is “PDL1” from “*PrinterLanguage” of 1804 in the example of FIG. 18. It can also be recognized that the page description language of the printer driver used by the registered printer is “PDL1” from “*PrinterLanguage” of 1604 in the example of FIG. 16. In this case, the page description languages are the same, and the process proceeds to step S1906.

On the other hand, if the installer determines in S1905 that the page description languages are not the same, the installer advances the process to step S1914.

In step S1906, the installer creates a functional capacity table from the printer specification description file of the registered printer. A table of keywords of the printer functions and choice keywords of the functions is created to create the functional capacity table from the printer specification description file. An example of the printer specification description file of the registered printer is described in FIG. 16.

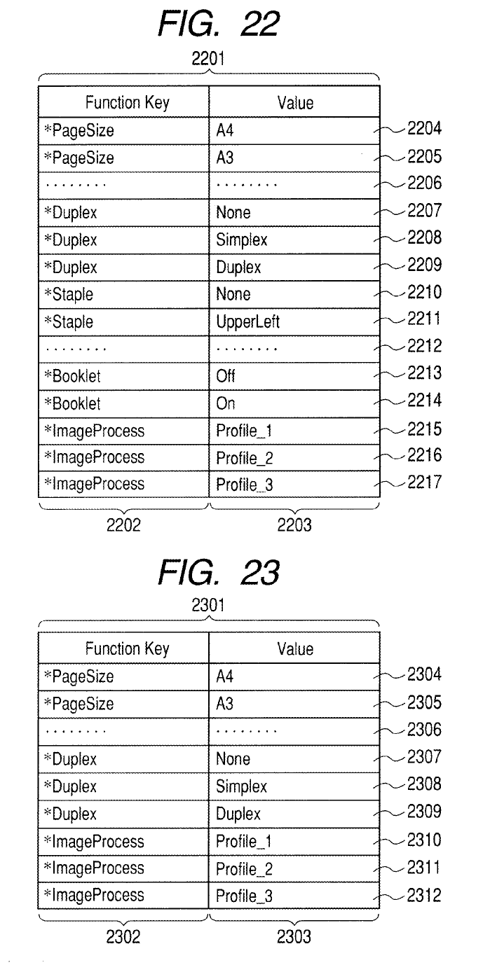

FIG. 22 is a diagram illustrating an example of the functional capacity table created from the printer specification description file of FIG. 16.

As shown in FIG. 22, a functional capacity table 2201 is constituted by a list of pairs of function keys and values of the function keys. To create the functional capacity table 2201, a function starting with “*OpenUI” is searched from the first line of the printer specification description file (FIG. 16).

There is “*OpenUI” in 1606 of the file of FIG. 16, and “*PageSize” indicating a function in the line is set as a function key. Values that can be selected in relation to the function key are searched. The search is possible by extracting values from the lines starting with “*PageSize” until “*CloseUI” appears. Specifically, there is “*PageSize:A3” in 1608, and it can be recognized that a value that can be taken by the “PageSize” function is “A3”. The similar process is repeated, and the file is searched until the end of the file. As a result, the functional capacity table 2201 of the printer driver as shown in FIG. 22 is completed.

In step S1907, the installer creates a functional capacity table of the printer to be registered. An example of the printer specification description file of the printer to be registered will be described in FIG. 18.

FIG. 23 is a functional capacity table created from the printer specification description file of FIG. 18. The creation method of the functional capacity table is the same as that of the functional capacity table of FIG. 22, and the description will not be repeated.

In step S1908, the installer compares the functional capacity table of the registered printer created in S1906 and the functional capacity table of the printer to be registered created in S1907. The comparison of S1908 is made to determine whether the functional capacity table of the printer to be registered includes the functional capacity table of the registered printer.

In step S1909, the installer determines whether the functional capacity table of the printer to be registered includes the functional capacity table of the registered printer based on the comparison result of S1908. If the installer determines in S1909 that the functional capacity table of the printer to be registered does not include the functional capacity table of the registered printer, the process proceeds to step S1911.

In the present embodiment, the functional capacity table 2201 (FIG. 22) of the registered printer and a functional capacity table 2301 (FIG. 23) of the general-purpose printer to be registered are compared to determine the inclusion relationship. In the example, the functional capacity table 2301 of the printer to be registered does not include the functional capacity table 2201 of the registered printer. Specifically, “*Staple” and “*Booklet” not included in the functions of the general-purpose printer to be registered are in the registered printer. Therefore, the installer determines that the table 2301 does not include the table 2201 and advances the process to step S1911. More specifically, if the installer determines No in S1909, the installer determines that printer-related information (printer specification description file and printer setting file) of the registered printer can be used and advances the process to step S1911.

In step S1911, the installer uses the information of the printer queue included in the registration information of the registered printer as well as the printer specification description file and the printer setting file of the registered printer to register the printer that uses the general-purpose printer driver to the print system.

The information of the printer queue included in the registration information of the registered printer is registered in “DeviceURI” in the printer registration information of the printer (for example, 904 of FIG. 9). The printer specification description file of the registered printer is stored in the “/etc/cups/ppd/” directory of the external storage device 212 in a ppd file with the identifier of the registered printer as the file name. The printer setting file of the registered printer is stored in the “/usr/Libraries/Preferences/” directory of the external storage device 212 in a plist file with the identifier of the registered printer as the file name.

Therefore, the installer uses the identifier and the name of the registered printer for the information of the identifier, the name, and the printer queue of the printer to be registered and uses the name of the general-purpose printer driver for the printer driver name used by the printer to be registered to generate the printer registration information. The installer then registers (overwrites) the printer registration information in “printer.conf” 1002 stored in the “/etc/cups/” directory 1001 of the external storage device 212. As described, the printer specification description file and the printer setting file of the registered printer are determined by the identifier of the printer. Therefore, the printer specification description file and the printer setting file of the registered printer are used for the files of the printer to be registered in S1911. As a result, the printer registered in S1911 is a printer using the printer driver object of the general-purpose printer driver and using the printer queue, the printer specification description file, and the printer setting file of the registered printer.

The printer specification description file and the printer setting file are in a general-purpose format. Therefore, the functions that cannot be interpreted by the general-purpose printer driver module is ignored, and the files can be used by the general-purpose printer driver module without problems. According to the registration procedure, the functions and the setting storage of the individually corresponding printer driver are automatically used and registered when the functions of the general-purpose printer driver to be installed are not excellent. Therefore, the previous setting is applied to the general-purpose printer driver to be installed, and the effort of registering the printer information (such as print queue) and setting the environment of the printer driver can be saved. When the registration process of S1911 is finished, the process proceeds to step S1913.

On the other hand, if the installer determines in S1909 that the functional capacity table of the printer to be registered includes the functional capacity table of the registered printer, the process proceeds to step S1912. More specifically, if the installer determines Yes in 1909, the installer determines that the printer-related information (printer specification description file and printer setting file) of the registered printer cannot be used and advances the process to step S1912.

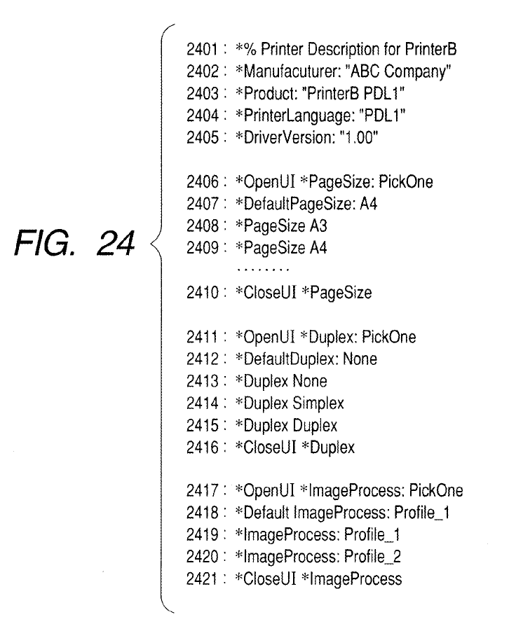

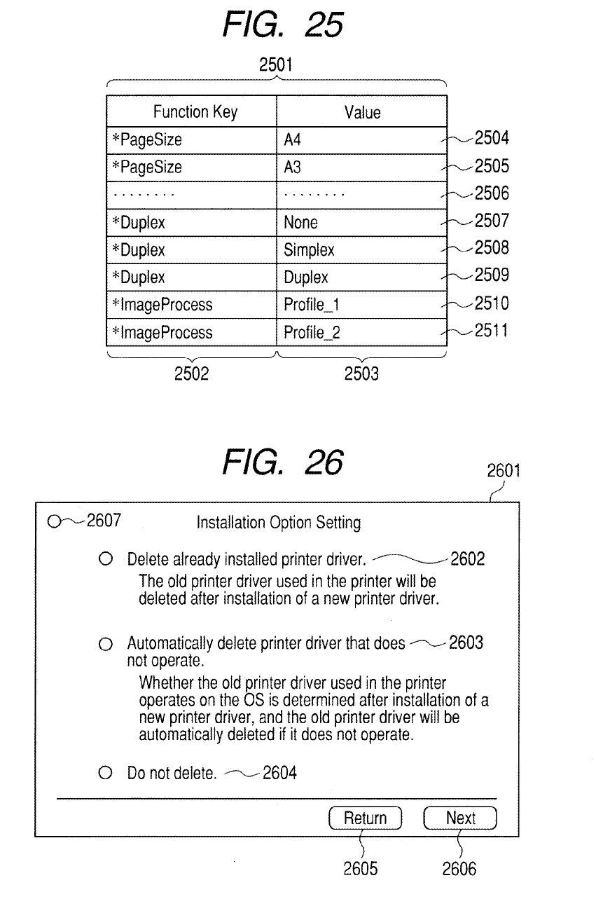

The printer specification description file of the registered printer is illustrated in FIG. 24 as an example, and the functional capacity table of the registered printer created from the printer description file of FIG. 24 is illustrated in FIG. 25 in the description.

FIG. 24 is a diagram illustrating an example of the printer specification description file of the individually corresponding printer driver. FIG. 25 is a diagram illustrating an example of the functional capacity table created from the printer specification description file of FIG. 24. The creation method of the functional capacity table is the same as described above, and the description will not be repeated.

A functional capacity table 2501 of the registered printer (FIG. 25) and the functional capacity table 2301 of the general-purpose printer to be registered (FIG. 23) are compared to determine the inclusion relationship. In the example, the functional capacity table 2301 of the general-purpose printer to be registered includes the functional capacity table 2501 of the registered printer. Specifically, all functions of the registered printer are included in the functions of the general-purpose printer to be registered. Therefore, the installer determines that the table 2301 includes the table 2501 and advances the process to step S1912.

In step S1912, the installer uses the information of the printer queue included in the registration information of the registered printer, the printer specification description file of the general-purpose printer driver, and the printer setting file of the registered printer to register the printer that uses the general-purpose printer driver to the print system.

Therefore, printer registration information is generated in which the identifier and the name of the registered printer are used for the identifier, the name, and the information of the printer queue of the printer to be registered, and the name of the general-purpose printer driver is used for the printer driver name used by the printer to be registered. The printer registration information is registered (overwritten) in “printer.conf” 1002 stored in the “/etc/cups/” directory 1001 of the external storage device 212. The printer specification description file of the general-purpose printer overwrites the “/etc/cups/ppd/” directory 1201, with the identifier of the registered printer as the file name (for example, “PrinterB_{—}192.168.1.5_.ppd”). The printer setting file of the printer is not particularly changed.

As described, the printer specification description file and the printer setting file of the registered printer are determined by the identifier of the printer. Therefore, the printer specification description file of the general-purpose printer driver is used as the file of the printer registered in S1912. The printer setting file of the registered printer is used as the file of the printer registered in S1912. Therefore, the printer driver module and the printer specification description file of the general-purpose printer driver are used for the printer registered in S1912, and the registered printer uses the printer queue and the printer setting file of the registered printer.

In this way, if the printer functional capacity of the general-purpose printer is determined to be excellent, new functions are used as the printer functions, and the printer setting file of the registered printer is used in the user setting.

According to the registration procedure, if the functions of the general-purpose printer driver to be installed are excellent, the printer functions of the driver are automatically used, and the setting storage of the already installed individually corresponding printer driver is used and registered. Therefore, the previous setting is applied to the general-purpose printer driver to be installed. Thus, the effort of registering the printer information (such as print queue) and setting the environment of the printer driver can be saved. When the registration process of S1912 is finished, the process proceeds to step S1913.

In S1911 and S1912, the name in the printer registration information of the registered printer is used for the name of the printer to be registered to overwrite the printer registration information. However, a name different from the name in the printer registration information of the registered printer may be used for the name of the printer to be registered to add new printer registration information to “printer.conf”.

In step S1913, the installer executes a deletion process of the registered printer and the printer driver used by the registered printer. FIG. 20 illustrates the process of S1913 in detail, and the process will be described along with FIG. 20.

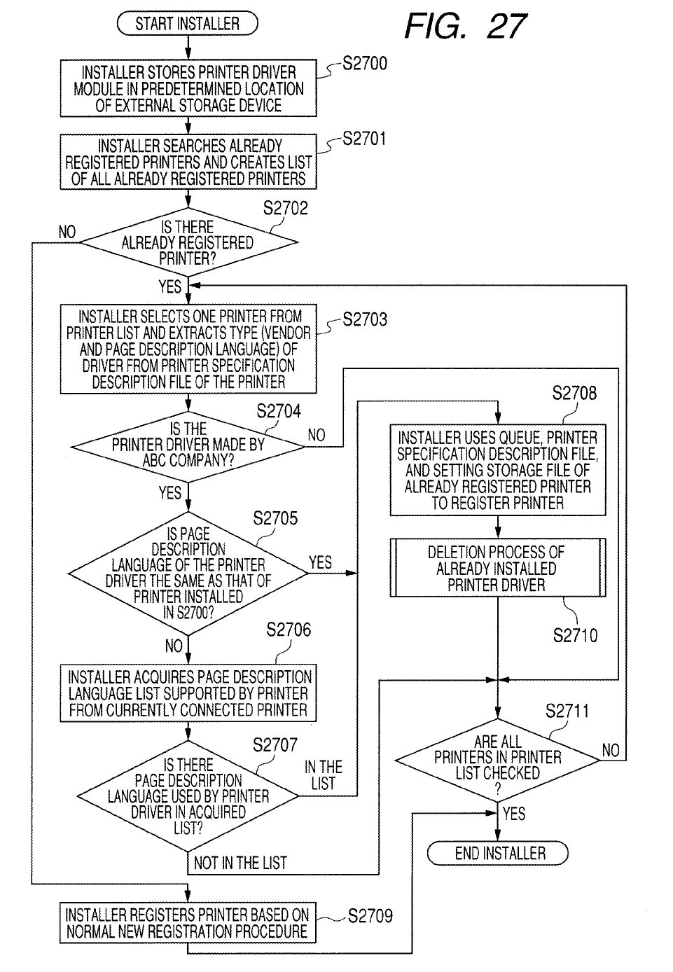

After the activation, the installer displays a dialog shown in FIG. 26 before starting the process of FIG. 19 and receives a setting operation of an option related to the deletion of the printer.

FIG. 26 is a diagram illustrating an example of the dialog for setting the option related to the deletion of the printer displayed by the installer.

As shown in FIG. 26, a dialog 2601 includes three options 2602, 2603, and 2604. Reference numeral 2602 denotes an option for designating the deletion of an old printer after the installation of a new printer driver. Reference numeral 2603 denotes an option for designating automatic deletion of the old printer when the old printer does not operate on the current OS. Reference numeral 2604 denotes an option for designating not to delete the old printer driver. When the user instructs a next button 2606 after selecting one of the options, the installer detects the operation, stores the information of the selected option in the RAM 204, and starts the process of the flow chart of FIG. 19. If the user instructs a cancel button 2605, the installer detects the operation and ends the process without executing the installation process.

Hereinafter, the flow chart of FIG. 20 will be described.

In step S2001, the installer acquires the choice of the option (designation result of option) designated in the installation option designation dialog 2601 (FIG. 26) from the RAM 204.

In step S2002, the installer switches the process according to the designation result of option acquired in S2001. If the installer determines that the option of not deleting (2604) is designated, the installer does not delete the printer driver, ends the process of FIG. 20, and returns the process to the flow chart of FIG. 19.

If the installer determines that the option of deleting (2602) is designated, the installer advances the process to step S2006. In step S2006, the installer deletes the module of the printer driver installed according to the already registered printer selected in S1902 of FIG. 19. The installer ends the process of FIG. 20 and advances the process to step S1914 of FIG. 19.

If the installer determines that the automatic option (2603) is designated, the installer advances the process to step S2003. In step S2003, the installer acquires the driver version of the printer driver used by the registered printer selected in S1902 of FIG. 19 from the printer specification description file of the printer driver. The printer driver used by the registered printer selected in S1902 of FIG. 19 will be called “already installed printer driver”. Specifically, for example, if FIG. 16 is the printer specification description file of the already installed printer driver, a value “PDL 1.00” is acquired from “*DriverVersion” of 1605.

In step S2004, the installer determines whether the already installed printer driver operates on the current OS 802 from the version acquired in S2003. The installer holds the version of the printer driver and the information of the version of the operating OS and uses the information to execute the determination process.

In step S2005, the installer determines whether to delete the already installed printer driver based on the result of determination of S2004. If the already installed printer driver is the version that operates on the current OS, the installer determines not to delete the printer driver and ends the process of FIG. 20. The process then proceeds to step S1914 of FIG. 19.

On the other hand, if the already installed printer driver is the version that does not operate on the current OS as a result of the determination of S2004, the installer determines to delete the printer driver in S2005. The process then proceeds to step S2006. In step S2006, the installer deletes the module of the already installed printer driver. The installer ends the process of FIG. 20 and advances the process to step S1914 of FIG. 19. If the printer driver to be deleted in S2006 is already deleted, the installer ends the process of FIG. 20 and advances the process to step S1914 of FIG. 19.

If a name different from the name of the registered printer is used for the name of the printer registered in S1911 and S1912, the printer registration information of the registered printer is also deleted from “printer.conf” in S2006.

According to the process of FIG. 20, the effort of deleting the already installed printer driver and deleting the already registered printer can be saved.

In step S1914 of FIG. 19, the installer determines whether all printers in the list created in S1901 are checked (whether process of S1903 to S1913 is finished). If the installer determines in S1914 that not all printers are checked yet, the installer returns the process to step S1903 and moves the process to the next printer in the list.

On the other hand, if the installer determines in S1914 that all printers are already checked, the installer ends the process of FIG. 19.

As described, there are the following advantages in the installation of the general-purpose printer driver in the computer 101 already installed with the individually corresponding printer driver. The user can automatically install the general-purpose printer driver without performing a cumbersome installation operation of deleting the already installed individually corresponding printer driver, newly installing the general-purpose printer driver, and setting the default. The default setting set in the individually corresponding printer driver can also be automatically taken over by the general-purpose printer driver. Therefore, the effort of registering the printer information (such as print queue) and setting the environment of the printer driver can be saved in the installation of the general-purpose printer driver on the apparatus installed with the individually corresponding printer driver, etc.

### Second Embodiment

A second embodiment will now be described. The embodiment will be described with reference to FIGS. 1 to 3, 6 to 18, 24, and 27 to 29. The content up to FIG. 24 is the same as that of the first embodiment. Therefore, the description will not be repeated, and FIGS. 27 to 29 will be described.

### <Installation Procedure>

FIG. 27 is a flow chart illustrating an installation procedure of the second embodiment of the present invention, and the procedure will be described along with FIG. 27. Steps S2700 to S2705 are the same as steps S1900 to S1905 of FIG. 19, and steps S2709, S2710, and S2711 are the same as steps S1910, S1913, and S1914 of FIG. 19. Therefore the description will not be repeated, and steps S2706 of S2708 will be described in detail. As in FIG. 19, a general-purpose printer driver installed in S2700 will be simply called “general-purpose printer driver”, and an already registered printer selected in S2703 will be called “registered printer” in FIG. 27.

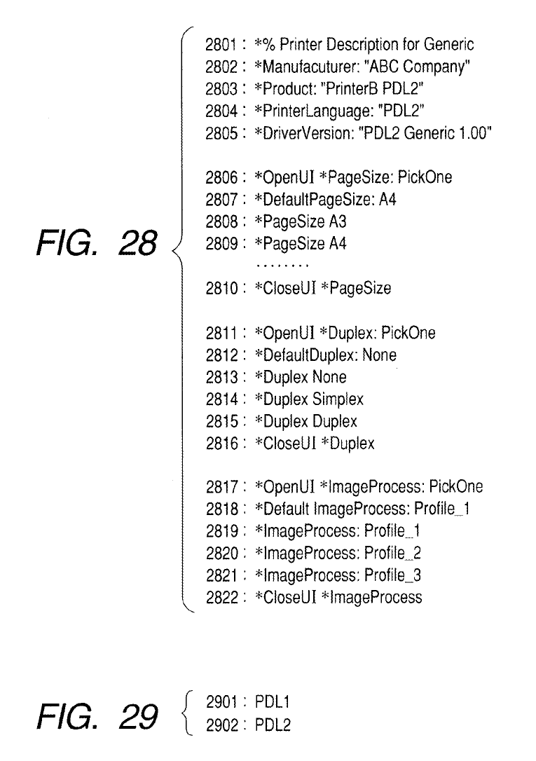

In the example described, the printer specification description file of the registered printer is illustrated in FIG. 24, and the printer specification description file of the general-purpose printer to be installed is illustrated in FIG. 28. FIG. 28 is a diagram illustrating an example of the printer specification description file of the general-purpose printer driver.

In step S2705, if the page description language of the printer driver used by the registered printer is the same as the page description language of the general-purpose printer driver, the installer advances the process to step S2708.

On the other hand, if the page description language of the printer driver used by the registered printer is not the same as the page description language of the general-purpose printer driver in S2705, the installer advances the process to step S2706.

For example, it can be recognized that the page description language of the printer driver used by the registered printer is “PDL1” from “*PrinterLanguage” of 2404 in the example of FIG. 24. It can also be recognized that the page description language of the general-purpose printer driver is “PDL2” from “*PrinterLanguage” of 2804 in the example of FIG. 28. Since “PDL1” and “PDL2” are different page description languages, the general-purpose printer driver cannot usually replace the printer driver used by the registered printer. However, some printers can process a plurality of types of page description languages. For example, it is assumed that a printer supports (can use) two types of page description languages “PDL1” and “PDL2”, and the registered printer uses the printer driver of “PDL1”. In this case, the printer can make an interpretation even if the page description language of the general-purpose printer driver is “PDL2”. Therefore, there is no problem in the operation when the printer is registered to use the general-purpose printer driver.

Therefore, in step S2706, the installer acquires a page description language that the printer can use (supported) from the registered printer.

FIG. 29 is a diagram illustrating an example of the page description language handled by the printer acquired from the printer. As shown in FIG. 29, the printer supports “PDL1” and “PDL2”.

In step S2707, the installer determines whether there is a page description language used by the printer driver (the general-purpose printer driver) in the page description languages acquired from the printer in S2706. If the installer determines that there is a page description language used by the printer driver in the page description languages acquired from the printer in S2707, the installer advances the process to step S2708. In the example, the page description language of the general-purpose printer driver is “PDL2”, and the page description languages handled by the printer are “PDL1” and “PDL2” as shown in FIG. 29. Therefore, the installer determines that the printer driver can be used and advances the process to step S2708. More specifically, if the installer determines Yes in S2705 or determines that the language is in the list in S2707, the installer determines that the printer-related information (printer specification description file and printer setting file) of the registered printer can be used. The installer then advances the process to step S2708.

In step S2708, as in step S1911 of FIG. 19, the installer uses the information of the printer queue included in the registration information of the registered printer as well as the printer specification description file and the printer setting file of the registered printer to register the printer that uses the general-purpose printer driver to the print system. The installer then advances the process to step S2710.

On the other hand, if the installer determines in S2707 that there is no page description language used by the printer driver in the page description languages acquired from the printer, the installer does not register the printer and advances the process to step S2711.

In S2708, the installer may be configured to determine the capacity of the printer to determine the printer specification description file and the printer setting file to be used according to the procedure of S1906 to S1909 of FIG. 19 of the first embodiment.

This eliminates the need for the cumbersome operation of deleting the registered printer that uses the individually corresponding printer driver and registering the printer that uses the general-purpose printer driver, even if the page description languages are different between the individually corresponding printer driver and the general-purpose printer driver. The setting information of the individually corresponding printer driver can be taken over to automatically register the printer that uses the general-purpose printer driver.

In the description of FIG. 27, the printer driver already installed in the apparatus before the installer installs a new printer driver is the individually corresponding printer driver, and the new printer driver is the general-purpose printer driver. However, the printer driver already installed in the apparatus and the new printer driver do not have to be the individually corresponding printer driver and the general-purpose printer driver as long as the drivers are compliant with the same printer apparatus, and the page description languages are different in the printer drivers.

Therefore, the effort of registering the printer information (such as print queue) and setting the environment can be saved in the installation of a printer driver with a page description language different from that of the printer driver in the apparatus already installed with the printer driver.

In FIG. 19, if the functions indicated by the printer specification description file of the general-purpose printer driver do not include the functions indicated by the printer specification description file of the registered printer, the printer specification description file and the printer setting file of the registered printer are used. However, the registration process of the printer may be executed as described below if there is no inclusion relationship between the functions indicated by the printer specification description file of the general-purpose printer driver and the functions indicated by the printer specification description file of the registered printer. More specifically, the printer specification description file and the printer setting file of the general-purpose printer driver are combined with the printer specification description file and the printer setting file of the registered printer to generate new printer specification description file and printer setting file. The printer setting file is generated so that the values of the printer setting file of the registered printer are used for the functions included in the printer specification description file of the registered printer. The generated printer specification description file and the printer setting file are used to control setting of the printer that uses the general-purpose printer driver.

Although CUPS is used as the print system in the description of the present embodiments, the present invention is not limited only to CUPS.

A printer driver is generally constituted by printer driver modules, such as a printer graphic driver, a printer interface driver, and a characteristic data file not only in CUPS, but also in other print systems. The setting information of the user in relation to the printer is registered in the print systems. The same applies to a printer driver corresponding to a print system of Windows (registered trademark). The printer graphic driver corresponds to the graphic rendering module 803. The printer interface driver corresponds to the UI control module 805. The characteristic data file corresponds to the printer specification description file 806. The setting information corresponds to the printer setting file 811.

Therefore, although details of the registration procedure are different, the general-purpose printer driver can be installed in a print system (print system of Windows (registered trademark)) other than CUPS as in the case of CUPS shown in the present embodiments. More specifically, the installer searches the printer registration information of the printer already registered in the print system. The installer also determines whether the printer-related information (printer specification description file and printer setting file) registered in the print system in relation to the searched printer registration information can be used. If the installer determines that the information can be used, the installer can use the information of the printer queue included in the registration information of the already registered printer and the printer-related information to register the printer that uses the general-purpose printer driver in the print system.

The configurations and the contents of various data described above are not limited to these. It is obvious that the data is constituted by various configurations and contents depending on the usage and objects.

Although an embodiment has been illustrated, the present invention can be in a form of an embodiment of, for example, a system, an apparatus, a method, a program, or a storage medium. Specifically, the present invention can be applied to a system constituted by a plurality of devices or to an apparatus made of one device.

As illustrated, in the installation of the general-purpose printer driver in the computer 101 already installed with the individually corresponding printer driver, the general-purpose printer driver can be easily (automatically) installed while the setting of user, etc. is maintained. Therefore, the effort of registering the printer information (such as print queue) and setting the environment of the printer driver can be saved.

According to the present embodiments, setting information of an individually corresponding printer driver can be taken over to easily install a new printer driver even in the installation of a general-purpose printer driver in an apparatus installed with the individually corresponding printer driver, etc. This can save the effort of registering the printer information and setting the environment of the printer driver.

Aspects of the present invention can also be realized by a computer of a system or apparatus (or devices such as a CPU or MPU) that reads out and executes a program recorded on a memory device to perform the functions of the above-described embodiment(s), and by a method, the steps of which are performed by a computer of a system or apparatus by, for example, reading out and executing a program recorded on a memory device to perform the functions of the above-described embodiment(s). For this purpose, the program is provided to the computer for example via a network or from a recording medium of various types serving as the memory device (e.g., computer-readable medium). In such a case, the system or apparatus, and the recording medium where the program is stored, are included as being within the scope of the present invention.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2009-112192, filed May1, 2009, which is hereby incorporated by reference herein in its entirety.

1. An information processing apparatus including a print system that is a program for managing a printer driver, the information processing apparatus comprising:
a storage unit configured to store a printer driver module of a general-purpose printer driver constituted by a binary object different from the printer driver in a memory of the information processing apparatus already installed with a printer driver;
a search unit configured to search registration information of a printer already registered in the print system;
a determination unit configured to determine whether printer-related information registered in the print system can be used in relation to the registration information searched by the search unit; and
a registration unit configured to use information of a printer queue included in the registration information of the already registered printer and the printer-related information to register a printer that uses the general-purpose printer driver in the print system if the determination unit determines that the printer-related information can be used.

2. The information processing apparatus according to claim 1, wherein the printer-related information includes printer specification information indicating functions that can be used in a printer and user setting information indicating setting information of the user for the printer.

3. The information processing apparatus according to claim 2, wherein the registration unit is configured to use the information of the printer queue included in the registration information of the already registered printer, printer specification information included in the printer driver module of the general-purpose printer driver, and the user setting information included in the printer-related information to register the printer that uses the general-purpose printer driver in the print system if the determination unit determines that the printer-related information cannot be used.

4. The information processing apparatus according to claim 2, wherein the determination unit is configured to compare the printer specification information of the printer already registered in the print system and the printer specification information of the general-purpose printer driver included in the printer driver module of the general-purpose printer driver and to determine that the printer-related information can be used if functions indicated by the printer specification information of the already registered printer include functions indicated by the printer specification information of the general-purpose printer driver.

5. The information processing apparatus according to claim 1, wherein the determination unit is configured to determine that the printer-related information can be used if a page description language of the printer driver used by the already registered printer is equal to a page description language of the general-purpose printer driver.

6. The information processing apparatus according to claim 1, wherein the determination unit is configured to determine that the printer-related information can be used if page description languages that can be used in the already registered printer include the page description language of the general-purpose printer driver.

7. The information processing apparatus according to claim 6, wherein the determination unit is configured to communicate with the already registered printer to acquire information of the page description languages that can be used in the printer.

8. The information processing apparatus according to claim 1, further comprising:
a deletion determination unit configured to determine whether to delete the printer driver used by the already registered printer; and
a deletion unit configured to delete the printer driver module of the printer driver used by the already registered printer without deleting the related information of the already registered printer if the deletion determination unit determines to delete the printer driver used by the already registered printer.

9. The information processing apparatus according to claim 8, wherein the deletion determination unit is configured to determine to delete the printer driver used by the already registered printer if the printer driver used by the already registered printer does not support the version of an operating system used by the information processing apparatus.

10. An installation method of printer driver carried out in an information processing apparatus including a print system that is a program for managing a printer driver, the installation method comprising:
a storage step of storing a printer driver module of a general-purpose printer driver constituted by a binary object different from the printer driver in a memory of the information processing apparatus already installed with a printer driver;
a search step of searching registration information of a printer already registered in the print system;
a determination step of determining whether printer-related information registered in the print system can be used in relation to the searched registration information; and
a registration step of using information of a printer queue included in the registration information of the already registered printer and the printer-related information to register a printer that uses the general-purpose printer driver in the print system if it is determined in the determination step that the printer-related information can be used.

11. The installation method of printer driver according to claim 10, wherein the printer-related information includes printer specification information indicating functions that can be used in a printer and user setting information indicating setting information of the user for the printer.

12. The installation method of printer driver according to claim 11, wherein in the registration step, the information of the printer queue included in the registration information of the already registered printer, printer specification information included in the printer driver module of the general-purpose printer driver, and the user setting information included in the printer-related information are used to register the printer that uses the general-purpose printer driver in the print system if it is determined in the determination step that the printer-related information cannot be used.

13. The installation method of printer driver according to claim 11, wherein in the determination step, the printer specification information of the printer already registered in the print system is compared with the printer specification information of the general-purpose printer driver included in the printer driver module of the general-purpose printer driver, and it is determined that the printer-related information can be used if functions indicated by the printer specification information of the already registered printer include functions indicated by the printer specification information of the general-purpose printer driver.

14. The installation method of printer driver according to claim 10, wherein in the determination step, it is determined that the printer-related information can be used if a page description language of the printer driver used by the already registered printer is equal to a page description language of the general-purpose printer drive.

15. The installation method of printer driver according to claim 10, wherein in the determination step, it is determined that the printer-related information can be used if page description languages that can be used in the already registered printer include the page description language of the general-purpose printer driver.

16. The installation method of printer driver according to claim 15, wherein in the determination step, information of the page description languages that can be used in the printer is acquired by communicating with the already registered printer.

17. The installation method of printer driver according to claim 10, further comprising:
a deletion determination step of determining whether to delete the printer driver used by the already registered printer; and
a deletion step of deleting the printer driver module of the printer driver used by the already registered printer without deleting the related information of the already registered printer if it is determined in the deletion determination step to delete the printer driver used by the already registered printer.

18. The installation method of printer driver according to claim 17, wherein in the deletion determination step, it is determined to delete the printer driver used by the already registered printer if the printer driver used by the already registered printer does not support the version of an operating system used by the information processing apparatus.

19. A computer-readable storage medium storing a program causing a computer to execute the method according to claim 10.
